(19) United States
(12) Patent Application Publication
(10) Pub. No.: US 2026/0318851 A1
(43) Pub. Date: Oct. 15, 2026

(54) X-RAY INSPECTION DEVICE AND PROGRAM

(71) Applicant: System Square Inc., Niigata (JP)

(72) Inventor: Sachihiro NAKAGAWA, Niigata (JP)

(21) Appl. No.: 19/156,891

(22) PCT Filed: Feb. 27, 2023
(86) PCT No.: PCT/JP2023/007059

§ 371 Date: Aug. 15, 2025

(51) Int. Cl. G01N 23/083; G01N 23/04

(52) U.S. Cl. CPC G01N 23/083; G01N 23/04; G01N 2223/50; G01N 2223/643

(57) ABSTRACT

The X-ray inspection device includes a conveying unit that conveys the inspection target; a means for irradiating the inspection target with X-rays; a means for detecting energy of a photon of X-rays transmitted through an inspection target being conveyed; a means for counting the number of detected photons in each of a plurality of energy ranges at a predetermined cycle; a means for generating single-energy detection data based on the number of detected photons in each energy range; a setting means for accepting a setting of the detection data; a means for generating dual-energy detection data from any two single-energy detection data when dual-energy detection data is selected; and an inspection performing means that performs inspection using the selected detection data. The setting means is configured to allow the setting of at least one of single-energy detection data or dual-energy detection data.

### CROSS-REFERENCE TO RELATED APPLICATION

This application is a national stage application of International Application No. PCT/JP2023/007059, filed on Feb. 27, 2023.

### TECHNICAL FIELD

The present invention relates to an X-ray inspection device and program for inspecting foreign substances by irradiating an inspection target with X-rays.

### BACKGROUND ART

In general, at each stage of the manufacturing process, from production to packaging and shipping, inspections are conducted to check for the presence of foreign substances in products and packaging using inspection methods appropriate for the inspection target to be inspected and the types of foreign substances that may be contained in the inspection target (materials, size, etc.). Among these, X-ray inspection devices capable of non-destructive inspection irradiate the inspection target with X-rays and detect the transmitted X-rays to examine the presence of foreign substances inside that cannot be seen from the outside.

In X-ray inspection devices, there are two types for detecting image information as electrical signals: an indirect conversion type, which first converts X-rays into visible light using a scintillator and then converts them into electrical signals using a photodiode, and a direct conversion type, which directly converts X-rays into electrical signals using semiconductor elements such as CdTe. In the indirect conversion type, losses occur due to the light emission efficiency of the scintillator and the charge conversion efficiency of the photodiode, but in the direct conversion type, X-rays are directly converted into charges, resulting in high conversion efficiency.

Patent Document 1 discloses an X-ray inspection device using a direct conversion type energy discrimination photon counting sensor. In this device, the energy of photons of X-rays radiated toward the inspection target and transmitted through the inspection target and a belt conveyor conveying the inspection target is detected for each pixel, and the number of detected photons in each energy range during a predetermined time period is counted for each pixel. Then, an X-ray transmission image is generated in which the X-ray transmittance is expressed as a distribution of the detected photon counts, and inspection is performed using a dual-energy image obtained by image processing such as synthesis or subtraction of images in different energy ranges.

Patent document 2 discloses an X-ray inspection device that enables inspection using a dual-energy image suitable for the inspection target, by allowing the threshold value that defines the energy range, which is fixed in the device of Patent Document 1, to be changed to a value appropriate for each inspection target.

By generating a dual-energy image appropriately, an image with clear contrast between the inspection target and foreign substances can be obtained, enabling accurate detection of foreign substances even when the inspection target overlaps or has uneven surfaces.

### Prior Art References

### Patent Documents

Patent Document 1: JP 2010-091483 A
Patent Document 2: JP 6569070 B

### SUMMARY OF THE INVENTION

### Problems to be Solved by the Invention

Although a wide variety of items may be subject to inspection, in the case of chicken meat, for example, both hard bones and flat bones may stick to the meat as foreign substances during butchering. In such cases, flat bones are easier to detect with dual-energy detection data, but hard bones are more difficult to detect. Hard bones are easier to detect using single-energy detection data (data from a single-energy range), but currently, X-ray inspection devices capable of dual-energy detection can only perform inspections using dual-energy detection data.

The object of the present invention is to provide an X-ray inspection device and program capable of both inspection based on dual-energy detection data and inspection based on single-energy detection data.

### Means for Solving the Problems

The X-ray inspection device according to the present invention comprises: a conveying means that conveys an inspection target; an X-ray irradiation means that irradiates the inspection target with X-rays; an X-ray detection means that detects energy of a photon of X-rays transmitted through the inspection target under conveyance; a counting means that counts the number of detected photons in a plurality of different energy ranges at a constant interval in the X-ray detection means; a single-energy detection data generating means that generates single-energy detection data based on the number of detected photons from the inspection target for each energy range; a setting means that accepts a selection setting of the detection data; a dual-energy detection data generating means that generates dual-energy detection data from any two single-energy detection data when dual-energy detection data is selected in the setting means; and an inspection performing means that performs inspection using the detection data selected in the setting means, wherein the setting means is configured to allow the selection setting of any one of options consisting of two or more of the following: one or more single-energy detection data; dual-energy detection data; and a combination of dual-energy detection data and one or more single-energy detection data.

The setting means may be configured to allow selection setting of one or more single-energy detection data from all single-energy detection data generated by the single-energy detection data generating means.

The setting means may be configured to allow selection setting of any two single-energy detection data used for generating dual-energy detection data from all single-energy detection data generated by the single-energy detection data generating means.

The setting means may be configured to accept selection of the inspection target to be inspected from among a plurality of different inspection targets for which the selection setting to be selected from the options is specified in advance, and may accept the selection setting corresponding to the selected inspection target.

The X-ray inspection device according to the present invention may be realized by executing a program describing the functions of the X-ray inspection device of the present invention on a computer.

### Effects of Invention

According to the X-ray inspection device and program of the present invention, both inspection based on dual-energy detection data and inspection based on single-energy detection data are possible.

### BRIEF DESCRIPTION OF THE DRAWINGS

FIG. 1 is a functional block diagram of an X-ray inspection device 100 of the present invention.

FIGS. 2A and 2B show examples of setting energy ranges and counting the number of photons in each energy range.

FIG. 3 shows an actual setting pattern when one or more single-energy detection data are selected.

FIG. 4 shows an actual setting pattern when dual-energy detection data is selected.

FIG. 5 shows an example in which an option for selection settings is specified in advance for a plurality of inspection targets.

### DESCRIPTION OF EMBODIMENTS

Embodiments of the present invention will be described below with reference to the drawings. In the following description, portions already described are denoted by the same reference numerals, and a description thereof is omitted.

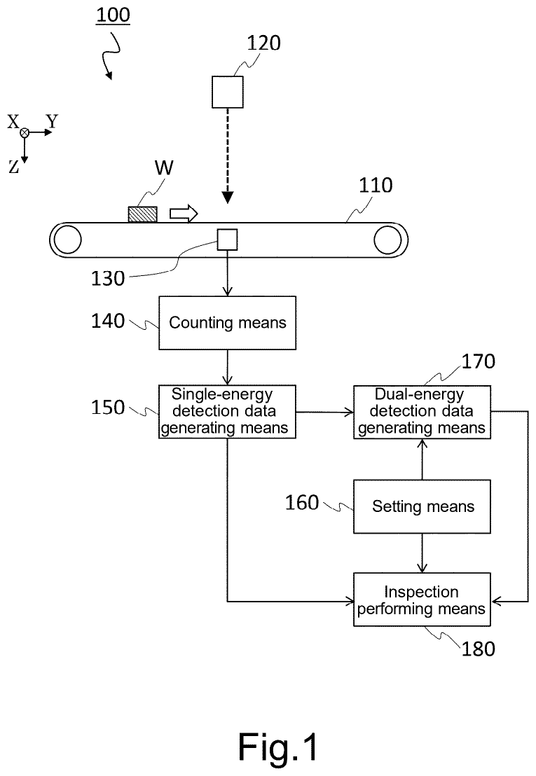

FIG. 1 shows a functional block diagram of an X-ray inspection device 100 of the present invention.

The X-ray inspection device 100 includes a conveying means 110, an X-ray irradiation means 120, an X-ray detection means 130, a counting means 140, a single-energy detection data generating means 150, a setting means 160, a dual-energy detection data generating means 170, and an inspection performing means 180.

The conveying means 110 is configured as a conveyor of any type that conveys the inspection target W placed thereon at a constant speed in the Y-axis direction. The conveying means 110 has a depth in the X-axis direction, which is perpendicular to the Y-axis direction, as viewed from the front. That is, the inspection target W is conveyed in the Y-axis direction on the XY plane.

The X-ray irradiation means 120 radiates X-rays toward the inspection target W conveyed by the conveying means 110.

The X-ray detection means 130 is arranged at a position capable of detecting X-rays that have been radiated from the X-ray irradiation means 120 and transmitted through the inspection target W conveyed at a constant speed by the conveying means 110, and detects the energy of photons of the X-rays that have transmitted through the inspection target W.

The X-ray detection means 130 is configured as a line sensor comprising a plurality of detection elements arranged in a line in the X-axis direction, each of which detects the energy of X-ray photons that have passed through the inspection target W. As the detection elements constituting the line sensor, semiconductor elements such as CdTe, which can directly convert incident photons into charge pulses with intensities corresponding to their energy, are suitable from the viewpoint of energy conversion efficiency and resolution.

The counting means 140 counts the number of detected photons for each detection element of the X-ray detection means 130 at a constant interval for a plurality of different energy ranges.

The constant interval is, for example, the time period during which the inspection target W moves across width in the Y-axis direction of the X-ray detection means 130. The number of detected photons in each energy range counted for each detection element of the X-ray detection means 130 is used to generate the information of each pixel within one line in the X-axis direction that constitutes an X-ray transmission image of the inspection target W. By setting the constant interval in this manner, while the inspection target W passes in the Y-axis direction between the X-ray irradiation means 120 and the X-ray detection means 130, whose positions relative to the conveying means 110 are fixed, the number of transmitted photons is repeatedly counted, and the information of each pixel in one line in the X-axis direction is collected seamlessly in the Y-axis direction. Therefore, by repeating the counting of the number of detected photons at the constant interval until the entire width of the inspection target W in the Y-axis direction passes through the X-ray detection means 130, it is possible to collect the information of all pixels constituting the X-ray transmission image of the inspection target W as viewed in the XY plane.

The energy of photons incident on the detection element of the X-ray detection means 130 is proportional to the charge pulse height output by the detection element. Therefore, it is possible to count the total number of detected photons in the entire energy range without considering the energy of the photons by simply counting the number of pulses incident on the detection elements during the constant interval of time. Additionally, each time a photon is incident, the energy corresponding to the charge pulse height output by the detection element is compared with one or more energy thresholds to determine which energy range the photon belongs to, thereby enabling the counting of detected photons in a plurality of different energy ranges. Note that the number of detected photons in each energy range may be counted directly, or by subtracting the count value of the energy range other than the energy range to be counted from the count value of a wider energy range.

The number of energy thresholds that define the energy ranges and the number of energy ranges in which the number of detected photons is counted may be set appropriately depending on the material of the inspection target W and the material of foreign substances. For example, when setting one energy threshold Vth, it is possible to set energy range A1 on the low-energy side and energy range A2 on the high-energy side, with the threshold Vth in between. When setting two energy thresholds, threshold Vth1 and threshold Vth2, which is higher than threshold Vth1, it is possible to set energy range A3 on the low-energy side of threshold Vth1, energy range A4 on the high-energy side of threshold Vth1 and on the low-energy side of threshold Vth2, and energy range A5 on the high-energy side of threshold Vth2. Additionally, it is possible to set the entire range on the high-energy side of threshold Vth1 as one energy range A6. Furthermore, it is possible to set the entire range on the low-energy side of threshold Vth2 as one energy range A7. When setting three or more thresholds, a plurality of energy ranges can be set using the same approach. Additionally, regardless of the number of thresholds set, it is possible to set the entire energy range as one energy range A8.

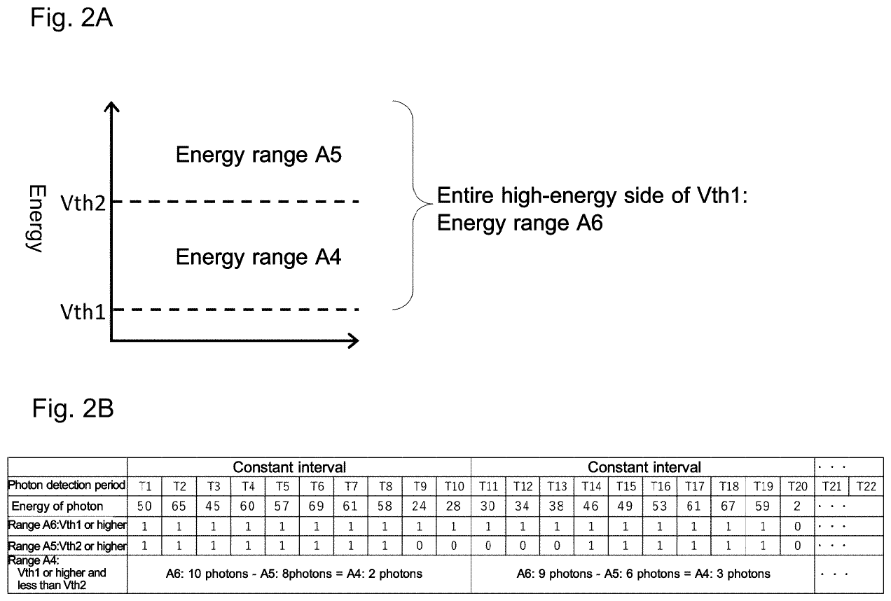

An example of setting energy ranges and counting the number of detected photons in each energy range is explained with reference to FIGS. 2A and 2B. In this example, two thresholds Vth1 and Vth2 are set, and as shown in FIG. 2A, the range positioned on the high-energy side of threshold Vth1 and the low-energy side of threshold Vth2 is defined as the energy range A4, the high-energy side of threshold Vth2 is defined as the energy range A5, and the entire high-energy side of threshold Vth1 is defined as energy range A6, thereby three energy ranges are set. Note that the low-energy side of threshold Vth1 is considered to be a noise range due to the likelihood of noise being mixed into the detected data, and is therefore excluded from the inspection range.

For the three energy ranges A4 to A6 set in this way, the number of photons incident on the detection element during the constant interval of time is counted directly for those with energies in energy ranges A5 and A6, and the number of photons with energies in energy range A4 is calculated by subtracting the count value in energy range A5 from the count value in energy range A6.

When the threshold value Vth1 is 5 and the threshold value Vth2 is 40, for example, as shown in FIG. 2B, the energies of 10 photons detected during each of the photon detection period T1 to T10 within the constant interval are 50, 65, 45, 60, 57, 69, 61, 58, 24, and 28, respectively, then, based on the values of the two thresholds, 10 photons in energy range A6 and 8 photons in energy range A5 can be directly counted. Then, the photons in energy range A4 can be calculated as 2 by determining the difference between the 10 photons in energy range A6 and the 8 photons in energy range A5.

Further, when the energies of 10 photons detected during each of the photon detection periods T11 to T20 in the next constant interval are 30, 34, 38, 46, 49,53, 61, 67, 59, and 2, respectively, then similarly, after directly counting 9 photons in energy range A6 and 6 photons in energy range A5, the difference between the 9 photons in energy range A6 and the 6 photons in energy range A5 can be calculated to be 3 photons in energy range A4.

The single-energy detection data generating means 150 generates detection data (single-energy detection data) based on the number of detected photons from the inspection target W for each energy range. The energy range referred to here is the energy range for which the number of detected photons is counted by the counting means 140. The detection data referred to here is typically the x-ray transmission image of the inspection target W as viewed in the XY plane, but may also be digital data that corresponds to the X-ray transmission image. The number of detected photons corresponding to each pixel of the X-ray transmission image has already been counted by the counting means 140, so the X-ray transmission image can be generated using this count.

The setting means 160 accepts a selection setting of the detection data to be used by the inspection performing means 180. Specifically, the setting means accepts a selection setting from any one of the options consisting of two or more of the following: one or more single-energy detection data, dual-energy detection data, and a combination of dual-energy detection data and one or more single-energy detection data. The method for accepting the selection setting is arbitrary. For example, the options may be displayed on a display means, such as a display, and an operator may select one of the options using a pointing device.

The single-energy detection data is effective for inspecting products with uniform thickness and for detecting foreign substances that are hard or high density. In particular, by using the single-energy detection data of multiple different energy ranges, it is possible to detect multiple types of bones and foreign substances with different X-ray transmission characteristics.

The dual-energy detection data is effective for detecting products with overlapping parts, uneven surfaces, and thin or soft foreign substances.

The combination of the dual-energy detection data and one or more single-energy detection data is effective for detecting both thin and hard bones, or for inspecting targets where both thin bones and hard bones are foreign substances.

From the viewpoint of enabling various types of inspections, it is desirable to include all of the following inspection options in the selection options: inspection based on single-energy detection data, inspection based on dual-energy detection data, and inspection based on both single-energy detection data and dual-energy detection data. However, any of these inspection options may be excluded from the selection options as necessary.

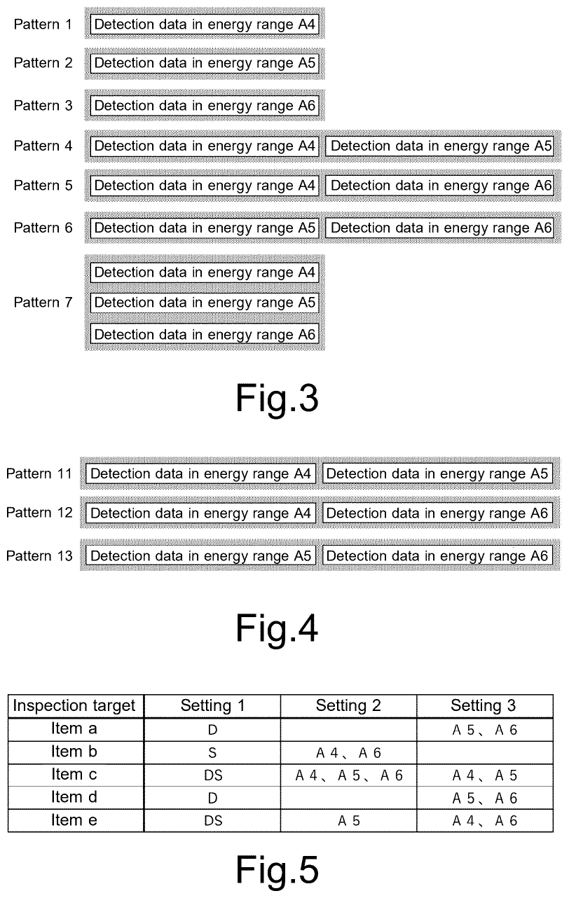

The options for selection setting to be accepted will be explained in more detail using the example of three energy ranges A4 to A6 set as shown in FIG. 3. The same approach can be used when there are more than three settings.

When one or more single-energy detection data are selected from the options, the actual settings are one of the seven patterns shown in FIG. 4, namely, only the detection data in energy range A4 (pattern 1), only the detection data in energy range A5 (pattern 2), only the detection data in energy range A6 (pattern 3), the detection data in energy range A4 and the detection data in energy range A5 (pattern 4), the detection data of energy range A4 and the detection data of energy range A6 (pattern 5), the detection data of energy range A5 and the detection data of energy range A6 (pattern 6), and the detection data of energy range A4, the detection data of energy range A5, and the detection data of energy range A6 (pattern 7).

The setting means 160 may be configured so that one of the patterns 1 to 7 is fixedly set. Alternatively, the setting means 160 may be configured to further accept selection settings of any pattern from all or a plurality of patterns 1 to 7, or instead of enabling selection settings of one or more single-energy detection data from the options, it may be configured to directly accept selection settings of any pattern from all or a plurality of patterns 1 to 7.

When the dual-energy detection data is selected from the options, the actual settings are one of the three patterns shown in FIG. 5, namely, the dual-energy detection data generated from the detection data in energy range A4 and the detection data in energy range A5 (pattern 11), dual-energy detection data generated from the detection data of energy range A4 and the detection data of energy range A6 (pattern 12), and dual-energy detection data generated from the detection data of energy range A5 and the detection data of energy range A6 (pattern 13).

The setting means 160 may be configured so that one of the patterns 11 to 13 is fixedly set. Alternatively, the setting means 160 may be configured to further accept selection settings of any pattern from all or a plurality of patterns 11 to 13, or instead of enabling selection settings of dual-energy detection data from the options, it may be configured to directly accept selection settings of any pattern from all or a plurality of patterns 11 to 13.

When a combination of dual-energy detection data and one or more single-energy detection data is selected from the options, the setting unit 160 may be configured so that one of patterns 11 to 13 is fixedly set for the dual-energy detection data, or so that it accepts further selection settings of any one of all or a plurality of patterns from patterns 11 to 13. The setting means 160 may be configured so that one of patterns 1 to 7 is fixedly set for one or more single-energy detection data, or so that it further accepts a selection setting of any one of all or a plurality of patterns 1 to 7. Additionally, the setting means 160 may be configured to directly accept selection settings for any of the patterns from all or a plurality of patterns from patterns 1 to 7 and selection settings for any of the patterns from all or a plurality of patterns from patterns 11 to 13, instead of allowing selection settings for combinations of dual-energy detection data and one or more single-energy detection data.

Alternatively, setting means 160 may be configured to accept selection of the inspection target to be inspected from among a plurality of different inspection targets, for which the selection setting to be selected from the above-mentioned options is specified in advance, thereby enabling it to accept the selection setting corresponding to the selected inspection target. With this configuration, settings can be completed simply by selecting the inspection target. Note that the units corresponding to the selection settings may be broader than a single inspection target, such as type or material, or narrower than a single inspection target, such as a manufacturing lot.

An example in which the selection settings are specified in advance for each of the items a to e that are inspection targets is shown in FIG. 5. Setting 1 is the setting pattern for the detection data of the inspection target, where S represents single-energy detection data, D represents dual-energy detection data, and DS represents dual-energy detection data and single-energy detection data. Setting 2 is the breakdown of single-energy detection data, where, for example, one or more of the energy ranges A4 to A6 are set. Setting 3 is the breakdown of the two single-energy detection data used to generate dual-energy detection data, for example, two are set from energy regions A4 to A6. By pre-storing information such as that shown in FIG. 5 in a fixed or rewritable manner in any storage means, when the selection of the inspection target is accepted, the setting means 160 can refer to the storage means and perform the selection setting.

The dual-energy detection data generating means 170 generates dual-energy detection data by applying processing such as synthesis and subtraction to any two single-energy detection data. Which two single-energy detection data are used may be determined in advance or may be selectable by the setting means 160 as described above.

The inspection performing means 180 performs the inspection using the detection data selected in the setting means 160. As examples of inspections performed using detection data, automatic inspection and visual inspection can be mentioned. In the case of automatic inspection, inspection performing means 180 may perform inspection by, for example, converting detection data into an image and performing image processing, or by performing numerical processing without converting the data into an image. In addition, inspection may be performed by inputting detection data into a learned model. In the case of visual inspection, inspection performing means 180 may, for example, perform inspection by converting detection data into an image and displaying it on a display device such as a display.

An X-ray inspection device according to the present invention may be realized by executing a program describing the functions of the X-ray inspection device of the present invention on a computer. Namely, the function of the X-ray inspection device of the present invention may be realized by the CPU reading and executing a program stored in any storage means in a computer.

There are pros and cons to each of the following methods: single-energy inspection using single-energy detection data obtained by irradiating the inspection target with X-rays and decomposing the transmitted X-rays into energy ranges; dual-energy inspection using dual-energy detection data; and simultaneous single- and dual-energy inspection. Inspection devices specialized in only one of these methods cannot handle a wide variety of inspection targets.

The single-energy inspection, which compares the transmittance in one energy range to clearly distinguish between products and foreign substances, is suitable for detecting products with uniform thickness and hard or high-density foreign substances. On the other hand, dual-energy inspection, which clarifies foreign substances by calculating the difference between images obtained in two (high and low) energy ranges and subtracting the unchanged portions, is suitable for detecting foreign substances in products with overlapping parts, uneven surfaces, and thin or soft foreign substances. Simultaneous single-energy and dual-energy inspections combine the advantages of both single-energy and dual-energy inspections and are effective, for example, in inspecting chicken meat, where both hard bones and flat bones may adhere as foreign substances during butchering.

According to the X-ray inspection device and program of the present invention, it is possible to perform simultaneous single-energy inspection and dual-energy inspection, and it is also possible to flexibly combine each inspection method to perform inspection, thereby enabling inspection of various inspection targets with only this device.

The present invention is not limited to the above embodiments. The embodiments are examples, and any embodiment that has substantially the same configuration as the technical concept described in the claims of the present invention and achieves similar effects is included in the technical scope of the present invention. In other words, changes can be made as appropriate within the scope of the technical concept expressed in the present invention, and forms with such changes and improvements are included in the technical scope of the present invention.

1. An X-ray inspection device comprising:
a conveying means that conveys an inspection target;
an X-ray irradiation means that irradiates the inspection target with X-rays;
an X-ray detection means that detects energy of a photon of X-rays transmitted through the inspection target under conveyance;
a counting means that counts the number of detected photons in a plurality of different energy ranges at constant intervals in the X-ray detection means;
a single-energy detection data generating means that generates single-energy detection data based on the number of detected photons from the inspection target for each energy range;
a setting means that accepts a selection setting of the detection data;
a dual-energy detection data generating means that generates dual-energy detection data from any two single-energy detection data when dual-energy detection data is selected in the setting means; and
an inspection performing means that performs inspection using the detection data selected in the setting means,
wherein the setting means is configured to allow the selection setting of any one of the options consisting of two or more of the following:
one or more single-energy detection data; dual-energy detection data; and
a combination of dual-energy detection data and one or more single-energy detection data.

2. The X-ray inspection device according to claim 1, wherein the setting means is configured to allow selection setting of one or more single-energy detection data from all single-energy detection data generated by the single-energy detection data generating means.

3. The X-ray inspection device according to claim 1, wherein the setting means is configured to allow selection setting of any two single-energy detection data used for generating dual-energy detection data from all single-energy detection data generated by the single-energy detection data generating means.

4. The X-ray inspection device according to claim 1, wherein the setting means is configured to accept selection of the inspection target to be inspected from among a plurality of different inspection targets for which the selection setting to be selected from the options is specified in advance, thereby allowing to accept the selection setting corresponding to the selected inspection target.

5. A program for causing a computer to function as the X-ray inspection device as claimed in claim 1.
